(19) United States
(12) Patent Application Publication
(10) Pub. No.: US 2024/0235376 A1
(43) Pub. Date: Jul. 11, 2024

(54) VOLTAGE REGULATOR WITH ACTIVE SHUNT

(71) Applicants: Advanced Micro Devices, Inc., Santa Clara, CA (US); ATI Technologies ULC, Markham (CA)

(72) Inventors: David King Wai Li, Austin, TX (US); Amanullah Samit, Markham (CA); Indrani Paul, Austin, TX (US); Meeta Surendramohan Srivastav, Austin, TX (US); Sriram Sambamurthy, Austin, TX (US)

(73) Assignees: Advanced Micro Devices, Inc., Santa Clara, CA (US); ATI Technologies ULC, Markham (CA)

(21) Appl. No.: 18/478,485

(22) Filed: Sep. 29, 2023

Related U.S. Application Data
(60) Provisional application No. 63/478,906, filed on Jan. 6, 2023.

(51) Int. Cl. H02M 1/32; H02M 3/02

(52) U.S. Cl. CPC H02M 1/32; H02M 3/02

(57) ABSTRACT

The disclosed voltage regulator circuit includes a capacitor bank configured for a first voltage step corresponding to a voltage undershoot, and a shunt circuit configured for a second voltage step exceeding the first voltage step. Various other methods, systems, and computer-readable media are also disclosed.

### CROSS REFERENCE TO RELATED APPLICATION

This application claims the benefit of U.S. Provisional Application No. 63/478,906, filed 6 Jan. 2023, the disclosure of which is incorporated, in its entirety, by this reference.

### BACKGROUND

As computing demands have increased, computing performance has accordingly advanced, resulting in increasingly complicated circuits and architectures. The dynamic and rapidly changing computing needs of a given device can cause transient events. For example, a load step up such as a sudden change in graphical output from black to white can cause voltage undershoots, whereas a load step down can cause voltage overshoots. Circuits such as a voltage regulator can protect the device's components from voltage undershoots and voltage overshoots.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for a voltage regulator with an active shunt.

FIG. 2A-B are a diagrams of load transient waveforms.

FIG. 3 is a simplified diagram of a shunt circuit for a voltage regulator.

FIG. 4A-B are a diagrams of load transient waveforms for a voltage regulator with an active shunt.

FIG. 5 is a flow diagram of an exemplary method for managing transient events for a voltage regulator using an active shunt.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a voltage regulator with an active shunt. As will be explained in greater detail below, implementations of the present disclosure provide a voltage regulator circuit with a shunt circuit. The voltage regulator circuit can have a capacitor bank with a reduced number of capacitors by being configured for voltage undershoot events and not voltage overshoot events. The shunt circuit can regulate the voltage overshoot events. Thus, the systems and methods provided herein can advantageously reduce a number of capacitors needed for a voltage regulator circuit, which can reduce system capacitance, reduce system power loss, extend battery life, and further reduce manufacturing costs.

In one implementation, a voltage regulator circuit includes a capacitor bank configured for a first voltage step corresponding to a voltage undershoot, and a shunt circuit configured for a second voltage step exceeding the first voltage step.

In some examples, the shunt circuit comprises a voltage comparator. In some examples, the shunt circuit comprises a resistor. In some examples, the shunt circuit comprises a Zener diode.

In some examples, the shunt circuit is integrated with the capacitor bank. In some examples, the shunt circuit is connected in parallel to the capacitor bank. In some examples, the capacitor bank is not capable of regulating the second voltage step.

In one implementation, a device for a voltage regulator with an active shunt includes a shunt circuit configured to couple to a voltage regulator circuit that is configured for a first voltage step corresponding to a voltage undershoot. The shunt circuit is configured for a second voltage step exceeding the first voltage step.

In some examples, the shunt circuit comprises a voltage comparator. In some examples, the shunt circuit comprises a resistor. In some examples, the shunt circuit comprises a Zener diode. In some examples, the shunt circuit is connected in parallel to the voltage regulator circuit.

In one implementation, a system for a voltage regulator with an active shunt includes a voltage regulator circuit configured for a first voltage step corresponding to a voltage undershoot, and a shunt circuit configured for a second voltage step exceeding the first voltage step.

In some examples, the voltage regulator circuit comprises a capacitor bank configured to regulate the first voltage step and not capable of regulating the second voltage step. In some examples, the voltage regulator circuit comprises a buck converter.

In some examples, the shunt circuit comprises a voltage comparator. In some examples, the shunt circuit comprises a resistor. In some examples, the shunt circuit comprises a Zener diode. In some examples, the shunt circuit is integrated with the voltage regulator circuit. In some examples, the shunt circuit is connected in parallel to the voltage regulator circuit.

Features from any of the implementations described herein can be used in combination with one another in accordance with the general principles described herein. These and other implementations, features, and advantages will be more fully understood upon reading the following detailed description in conjunction with the accompanying drawings and claims.

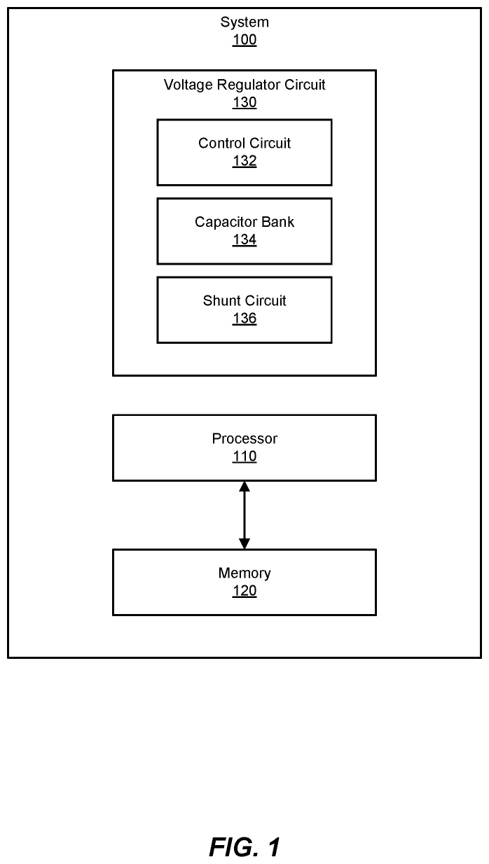

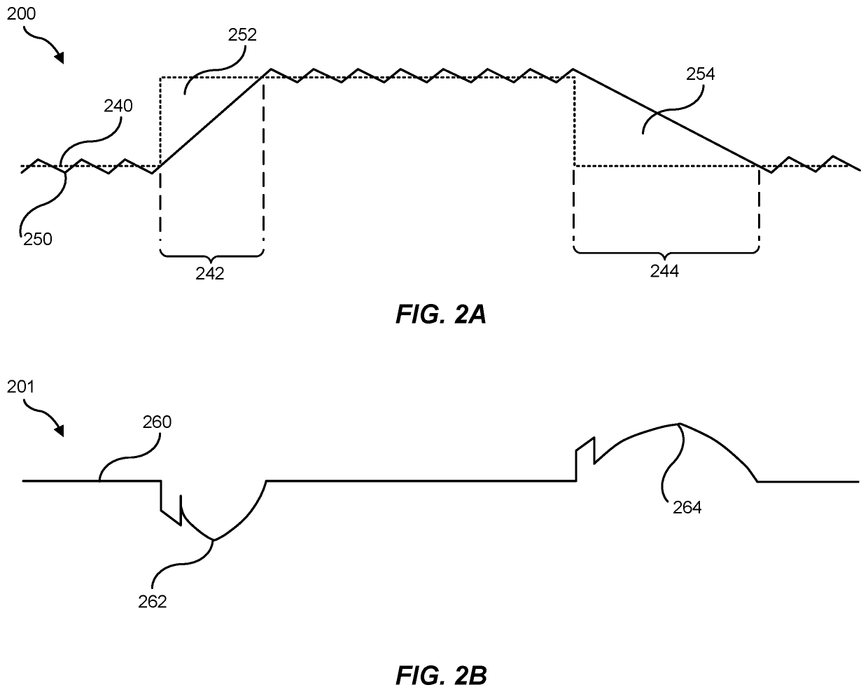

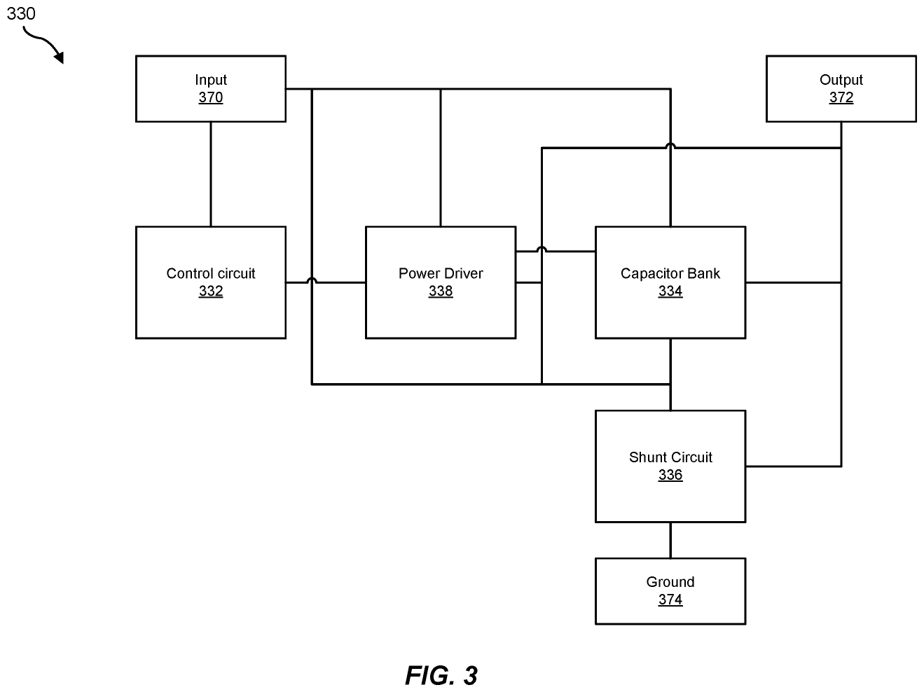

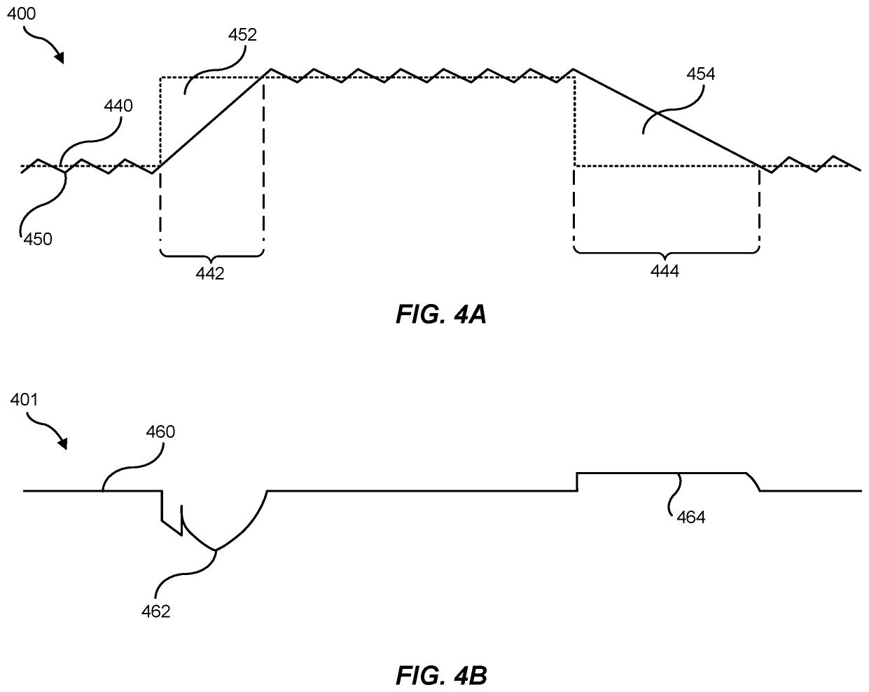

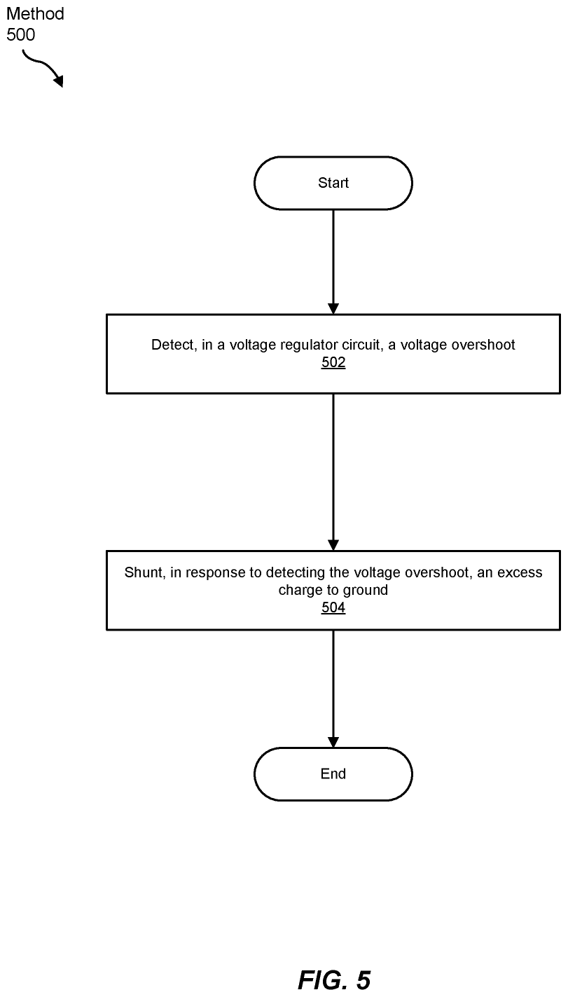

The following will provide, with reference to FIGS. 1-5, detailed descriptions of voltage regulators with active shunts. Detailed descriptions of example systems for voltage regulators with active shunts will be provided in connection with FIGS. 1 and 3. Detailed descriptions of transient events as waveforms with and without active shunts will be provided in connection with FIGS. 2 and 4. Detailed descriptions of corresponding methods will also be provided in connection with FIG. 5.

FIG. 1 is a block diagram of an example system 100 for a voltage regulator with an active shunt. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, system 100 includes a voltage regulator circuit 130. Voltage regulator circuit 130 corresponds to any voltage regulator circuit (e.g., a buck converter), power regulator circuit, power delivery network, and/or circuits thereof, that can deliver power from a power supply (e.g., a battery, AC, USB-C, other power interfaces, etc.) to various components of system 100 at appropriate voltages. Voltage regulator circuit 130 includes a control circuit 132, a capacitor bank 134, and a shunt circuit 136. Control circuit 132 corresponds to circuitry for controlling voltage regulator circuit 130 including, for example, a circuit for detecting transient events (e.g., a voltage comparator). Capacitor bank 134 corresponds to one or more capacitors, such as a bulk capacitor bank, which can be used by voltage regulator circuit 130 for transient events. Shunt circuit 136 corresponds to circuitry for shunting current to ground (e.g., a resistor, a Zener diode, etc.). In some examples, control circuit 132, capacitor bank 134, and/or shunt circuit 136 can be integrated or otherwise connected.

As system 100 operates, operational variances, such as changing workloads of components (e.g., processor 110 and/or memory 120), can cause transient events that need to be managed by voltage regulator circuit 130 and more specifically capacitor bank 134. FIG. 2A illustrates an example waveform diagram 200 and FIG. 2B illustrates an example waveform diagram 201 for transient events for a system such as system 100.

FIG. 2A illustrates a load current 240 (e.g., corresponding to a current drawn by components and supplies by voltage regulator circuit 130) as a dashed line and an inductor current 250 (e.g., corresponding to a charge stored by capacitor bank 134) as a solid line over time. FIG. 2B illustrates an output voltage 260 (e.g., corresponding to a voltage output of voltage regulator circuit 130) over time, matching with FIG. 2A.

FIG. 2A also illustrates an undershoot 252 and an overshoot 254. A voltage undershoot event can correspond to a load step-up, indicated by the step up in load current 240. The load step-up can occur in response to, for example, a sudden spike in workload in which the increased load draws increased current, which can cause a voltage droop 262 (in FIG. 2B). Because too great of a voltage undershoot can cause a brown out and crash the system, voltage regulator circuit 130 can use capacitor bank 134 (e.g., by releasing stored charge over an undershoot time 242) to regulate output voltage 260, as illustrated in FIGS. 2A and 2B.

A voltage overshoot event (e.g., overshoot 254) can correspond to a load step-down, indicated by the step down in load current 240. The load step-down can occur in response to, for example, a sudden drop in workload in which decreased load can cause a voltage spike 264. Because too great of a voltage overshoot can damage components, voltage regulator circuit 130 use capacitor bank 134 (e.g., by storing excess charge over an overshoot time 244) to regulate output voltage 260, as illustrated in FIGS. 2A and 2B.

Because a voltage regulator can use the same capacitor bank for both types of transient events, the capacitor bank can be designed with a minimum number of capacitors for regulating the different voltage steps corresponding to expected voltage undershoots and voltage overshoots. However, the number of capacitors needed for voltage overshoots can be greater (e.g., at least 10×) than the number of capacitors needed for voltage undershoots. Thus, the systems and methods described herein provide for a capacitor bank having a reduced number of capacitors (e.g., satisfying the number needed for voltage undershoots) and using a shunt circuit to shunt excess charge. FIG. 3 illustrates a simplified diagram of an example voltage regulator circuit 330 that corresponds to voltage regulator circuit 130.

FIG. 3 includes an input 370, an output 372, a ground 374, a control circuit 332 that corresponds to control circuit 132, a power driver 338, a capacitor bank 334 that corresponds to capacitor bank 134, and a shunt circuit 336 that corresponds to shunt circuit 136. Input 370 can correspond to, for example, an input voltage such as provided by a power supply. Output 372 can correspond to, for example, an output voltage provided to a load. Power driver 338 corresponds to a power driving circuit.

Shunt circuit 336 can shunt excess charge (as detected by control circuit 332) to ground 374. In some examples, shunt circuit 336 can be used to shunt excess charge from capacitor bank 334. For example, capacitor bank 334 can be configured for a first voltage step (e.g., a load step-up and/or a load step-down) corresponding to a voltage undershoot. Shunt circuit 336 can be configured for a second voltage step exceeding the first voltage step, for instance to regulate a voltage overshoot. Because capacitor bank 334 can, in some examples, have the minimum number of capacitors for the first voltage step, capacitor bank 334 can be incapable of regulating the second voltage step.

In some implementations, shunt circuit 336 can include one or more of a voltage comparator (e.g., a voltage level detection circuit which alternatively can be integrated with control circuit 332), a resistor, a Zener diode, etc. In some implementations, shunt circuit 336 can be integrated on a device circuit board, such as integrated with capacitor bank 334 or otherwise integrated with voltage regulator circuit 330. In some implementations, shunt circuit 336 can be connected in parallel to voltage regulator circuit 330 and/or capacitor bank 334. In some implementations, shunt circuit 336 can be separate from voltage regulator circuit 330, such as downstream from voltage regulator circuit 330, integrated into a chip, etc.

By shunting the excess charge, a voltage spike can be avoided. FIG. 4A illustrates an example waveform diagram 400 and FIG. 4B illustrates an example waveform diagram 401 for transient events for a system such as system 100.

FIG. 4A illustrates a load current 440 (e.g., corresponding to a current drawn by components and supplies by voltage regulator circuit 130) as a dashed line and an inductor current 450 (e.g., corresponding to a charge stored by capacitor bank 134) as a solid line over time. FIG. 4B illustrates an output voltage 460 (e.g., corresponding to a voltage output of voltage regulator circuit 130) over time, matching with FIG. 4A.

FIG. 4A also illustrates an undershoot 452 and an overshoot 454. Voltage regulator circuit 130 can use capacitor bank 134 (e.g., by releasing stored charge over an undershoot time 442) to regulate a voltage droop 462 of output voltage 460, as illustrated in FIGS. 4A and 4B.

In contrast to FIGS. 2A and 2B, voltage regulator circuit 130 use shunt circuit 136 (e.g., by shunting excess charge to ground over an overshoot time 444) to regulate output voltage 460, as illustrated in FIGS. 4A and 4B. In FIG. 4B, a shunted voltage spike 464 can avoid a peak (as in FIG. 2B) because the excess charge is shunted. Thus, capacitor bank 134 can be configured smaller (e.g., just large enough to regulate at most an undershoot) because shunt circuit 136 can regulate an overshoot.

FIG. 5 is a flow diagram of an exemplary method 500 for managing transient events of a voltage regulator with an active shunt. The steps shown in FIG. 5 can be performed by any suitable circuit, device, and/or system, including the system(s) illustrated in FIGS. 1 and/or 3. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein detect, in a voltage regulator circuit, a voltage overshoot. For example, control circuit 132 can detect a voltage overshoot for voltage regulator circuit 130.

At step 504 one or more of the systems described herein shunt, in response to detecting the voltage overshoot, an excess charge to ground. For example, shunt circuit 136 can shunt an excess charge to ground and away from capacitor bank 134.

As detailed above, point-of-load buck regulators often require bulk capacitors to handle two types of transient events: (1) load step up events, which can lead to a voltage droop and render a system-on-chip (SOC) to brown out if not properly protected, and (2) load step down events, which can lead to an overvoltage event that further leads to latch or permanent damage of the SOC.

Addressing the two types of transient events include increasing a regulator's bulk capacitor bank until both conditions are met, which can result in a large bulk capacitor bank requiring a lot of area. However, the load step down or overvoltage event can be the actual bottleneck to reducing bulk cap size. For example, in a 12-Vin:1-Vout application, capacitance required for C_overshoot>10*C_undershoot even with the consideration of loadline or adaptive voltage positioning.

If voltage overshoots can be managed without using the bulk capacitor bank, the bulk capacitors can be reduced to the level required to address voltage undershoots. This reduction can save on monetary and real estate costs of bulk capacitors. Reducing bulk capacitors can also advantageously reduce phantom power consumptions, P_phantom=0.5*C_bulk*delta V_rail*frequency, on rails that enters power gate (0-V) frequently (such as >60-Hz). This further leads to substantial power savings and extend usage such as for battery powered applications.

According to the capacitor charge equation—Q=CV, an excessive building of charge in a capacitor can lead to overvoltage. Therefore, to address overshoot, the excessive charge can be shunted to ground, as described herein. A shunt regulator can be a type of high-speed regulator used for shunting overvoltages, as described herein.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A voltage regulator circuit comprising:
a capacitor bank configured for a first voltage step corresponding to a voltage undershoot; and
a shunt circuit configured for a second voltage step exceeding the first voltage step.

2. The voltage regulator circuit of claim 1, wherein the shunt circuit comprises a voltage comparator.

3. The voltage regulator circuit of claim 1, wherein the shunt circuit comprises a resistor.

4. The voltage regulator circuit of claim 1, wherein the shunt circuit comprises a Zener diode.

5. The voltage regulator circuit of claim 1, wherein the shunt circuit is integrated with the capacitor bank.

6. The voltage regulator circuit of claim 1, wherein the shunt circuit is connected in parallel to the capacitor bank.

7. The voltage regulator circuit of claim 1, wherein the capacitor bank is not capable of regulating the second voltage step.

8. A device comprising:
a shunt circuit configured to couple to a voltage regulator circuit that is configured for a first voltage step corresponding to a voltage undershoot, wherein the shunt circuit is configured for a second voltage step exceeding the first voltage step.

9. The device of claim 8, wherein the shunt circuit comprises a voltage comparator.

10. The device of claim 8, wherein the shunt circuit comprises a resistor.

11. The device of claim 8, wherein the shunt circuit comprises a Zener diode.

12. The device of claim 8, wherein the shunt circuit is connected in parallel to the voltage regulator circuit.

13. A system comprising:
a voltage regulator circuit configured for a first voltage step corresponding to a voltage undershoot; and
a shunt circuit configured for a second voltage step exceeding the first voltage step.

14. The system of claim 13, wherein the voltage regulator circuit comprises a capacitor bank configured to regulate the first voltage step and not capable of regulating the second voltage step.

15. The system of claim 13, wherein the voltage regulator circuit comprises a buck converter.

16. The system of claim 13, wherein the shunt circuit comprises a voltage comparator.

17. The system of claim 13, wherein the shunt circuit comprises a resistor.

18. The system of claim 13, wherein the shunt circuit comprises a Zener diode.

19. The system of claim 13, wherein the shunt circuit is integrated with the voltage regulator circuit.

20. The system of claim 13, wherein the shunt circuit is connected in parallel to the voltage regulator circuit.
